(19) United States
(12) Patent Application Publication
(10) Pub. No.: US 2007/0174431 A1
(43) Pub. Date: Jul. 26, 2007

(54) Service notification device

(76) Inventor: Richard Querry, Laguna Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/335,981

(22) Filed: Jan. 20, 2006

(51) Int. Cl. G06F 15/173; G06F 15/16

(52) U.S. Cl. 709/219

(57) ABSTRACT

A service notification device is provided. In some embodiments, the service notification device is attached to a beverage container, and various positions of the service notification device communicate to a server that service is desired. In some embodiments, publicity is generated through information that is situated on the service notification device.

### BACKGROUND OF THE INVENTION

1. Field of the Invention

The invention in various embodiments relates to the service industry and generating publicity.

2. Description of the Related Art

It is common practice for companies to use promotional devices to generate publicity for their business, events, products, and many other things. For example, many companies distribute pens, flashlights, or mugs with business logos or other information that they desire to publicize. Many of these promotional products have become common place, which may affect the attention garnered by recipients of such products.

Promotional products distributed during group events typically generate attention and commentary among the event's participants. Distributing interesting and unique promotional products may provide desired publicity beyond common place promotional products.

### SUMMARY OF THE INVENTION

In some embodiments, a service notification device is provided that comprises a body and a notifier. Preferably the notifier is movable with respect to the body and has a plurality of positions, at least one position communicating to a server that service is desired. Preferably, information is situated on the notifier, and the information provides publicity.

In some embodiments, a method of publicizing information is provided that comprises distributing a service notification device that is intended be placed onto a beverage container. Preferably, the service notification device comprises a body and a notifier, and the notifier is movable with respect to the body. Preferably, the notifier has a plurality of positions, and at least one position communicates to a server that beverage service is desired. In some embodiments, information that is situated on the notifier is publicized.

In some embodiments, a method of manufacturing a service notification device is provided that comprises placing information onto a notifier and securing the notifier to a body. Preferably, the notifier is secured such that it is movable with respect to the body. In some embodiments, the notifier has a plurality of positions, and at least one position communicates that service is desired.

### BRIEF DESCRIPTION OF THE DRAWINGS

FIG. 1 is a perspective view of one embodiment of the invention;

FIG. 2 shows one embodiment of the invention attached to a beverage container in a position that communicates that service is not desired;

FIG. 3 shows one embodiment of the invention attached to a beverage container in a position that communicates that service is desired;

FIG. 4 shows an exploded view of the embodiment of FIG. 1.

FIG. 5 is an end view of one embodiment of the body 30;

FIG. 5A is a front view of the body 30 of FIG. 5.

### DETAILED DESCRIPTION OF THE PREFERRED EMBODIMENT

In some embodiments, the invention provides a device that provides notification that service is desired. The type of the service may be any in which observation by a server is necessary to ascertain that service is desired. In one embodiment, a device and method are provided that are used to provide notification to servers that beverage service is desired.

In some embodiments, the invention provides a beverage alert 10 that is attached to a beverage container 20. In such embodiments, the device may provide notification to servers that an individual or group associated with the beverage container 20 desires beverage service. Beverage service may include any service related to a beverage, which may include but is not limited to re-filling, substituting, removing, and/or requesting modification of a beverage. It is contemplated that the server in this embodiment could be anyone who serves drinks, which may include but is not limited to hosts/hostesses, professional servers, or any other individual.

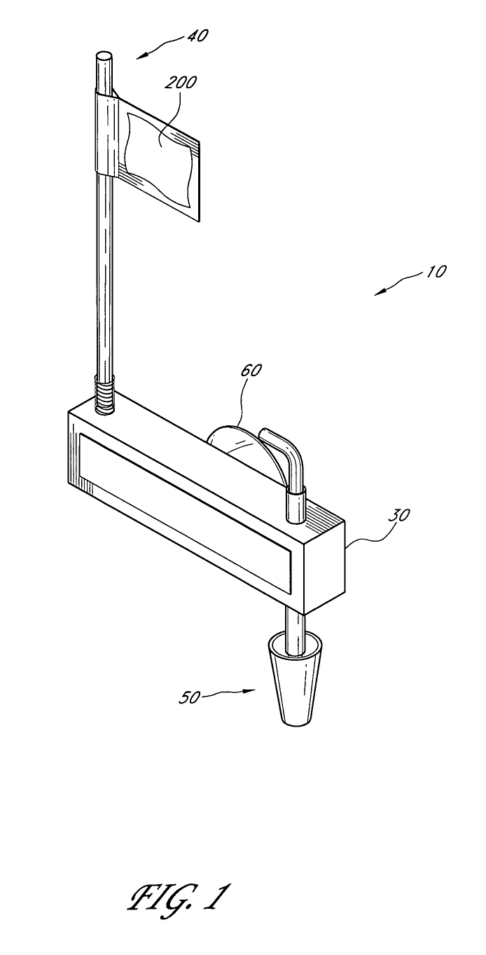

As depicted in FIG. 1, some embodiments of the invention comprise a body 30, notifier 40, activator 50, and attachment mechanism 60. Preferably, the notifier 40 is movable with respect to the body 30 and has a plurality of positions relative to the body 30. Each position of the notifier 40 may represent a communication to a server as to whether and/or what service is desired or not desired. In some embodiments, the activator 50 engages the notifier 40 to maintain the notifier 40 in one or more positions relative to the body 30. In some embodiments, the attachment mechanism 60 is configured to removably attach the beverage alert 10 to the beverage container 20.

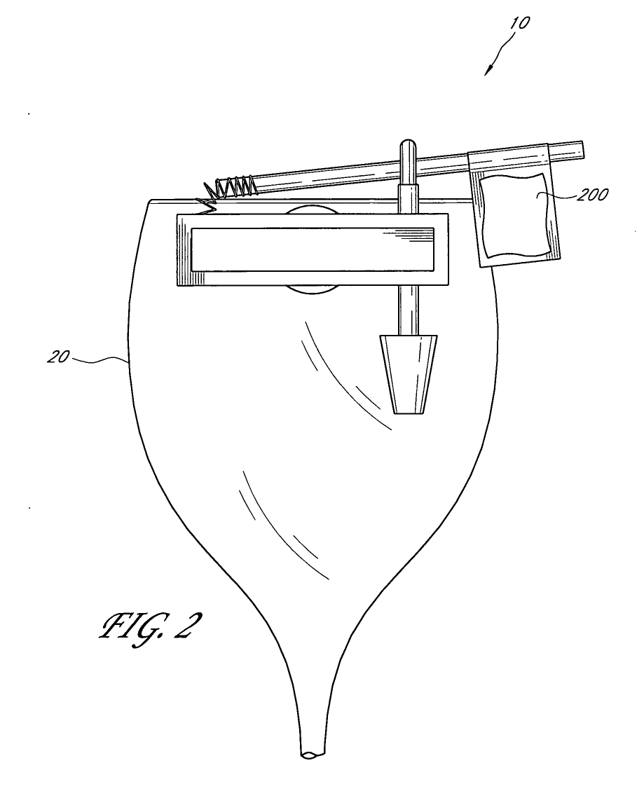

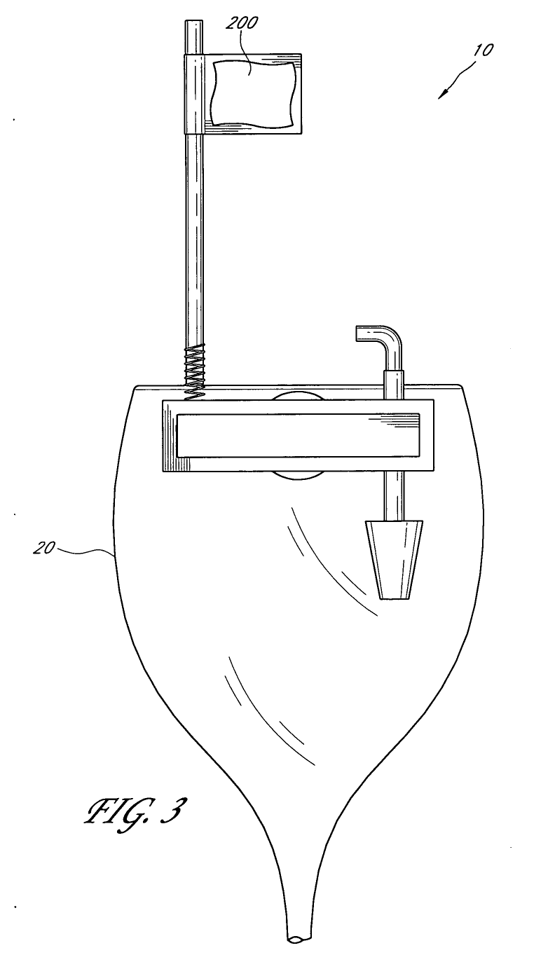

Preferably, relative movement is possible between the notifier 40 and the body 30. In some embodiments, the notifier 40 is in Position 1 when the activator 50 engages the notifier 40, as depicted in FIG. 2. In some embodiments, the notifier 40 is in Position 2 when the activator 50 does not engage the notifier 40, as depicted in FIG. 3. In some embodiments, Position 1 may communicate to a server that no service is desired, and Position 2 may communicate to a server that service is desired. In alternative embodiments, the notifier 40 has more than two positions and is capable of relaying more than two communications to a server.

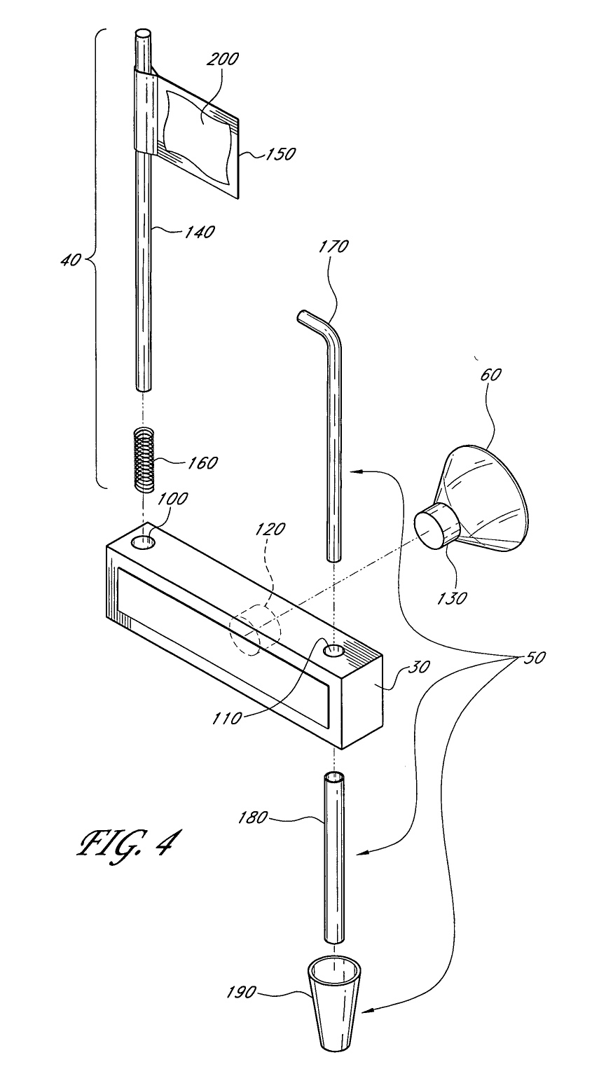

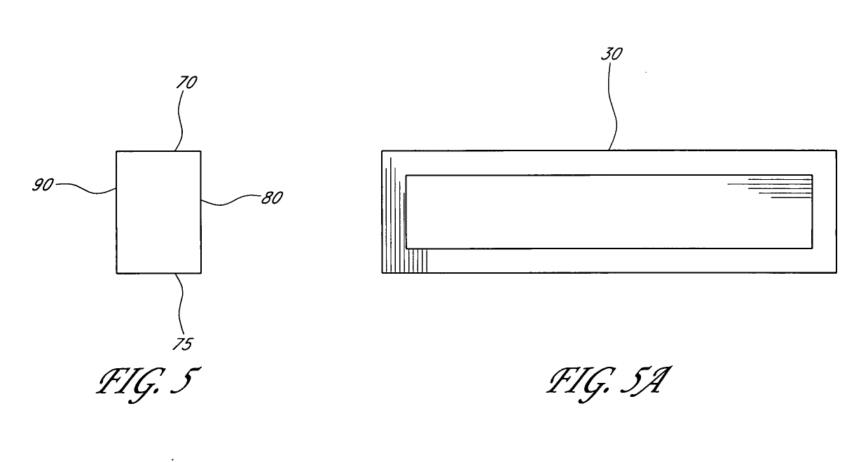

In some embodiments, the attachment mechanism 60, the notifier 40, and the activator 50 are mounted to the body. The body 30 can be any suitable size or shape and made of any suitable material. Preferably, the body 30 is rectangular in shape and is configured with a top surface 70, bottom surface 75, front surface 80, back surface 90, notifier hole 100, activator hole 110, and an attachment hole 120. See FIGS. 4, 5, and 5A. The attachment hole 120 can be at any location on any surface of the body 30. In some embodiments, the attachment hole 120 is on the back surface 90 and extends through a portion of the body 30 in a direction perpendicular to the back surface 90. The notifier hole 100 can be at any location on any surface of the body 30. In some embodiments, the notifier hole 100 is on the top surface 70 and extends through a portion of the body 30 in a direction perpendicular to the top surface 70. The activator hole 110 can be at any location on any surface of the body 30. In some embodiments, the activator hole 110 extends through the body 30 in a direction perpendicular to the top surface 70. It is also contemplated that the attachment mechanism 60, notifier 40 and, activator 50 could be attached to the body 30 by means other than holes.

The attachment mechanism 60 may be attached to a portion of the body 30 and configured to attach the drink alert 10 to the beverage container 20. The attachment mechanism 60 may be any suitable type (e.g., a suction cup, clip, adhesive, etc.). Preferably, the attachment mechanism 60 is a suction cup 60. The suction cup 60 allows simple removal of the drink alert 60, is easily reusable, does not leave residual material on the beverage container 20, and does not require use of the inside surface of the beverage container 20. In some embodiments, the suction cup 60 is attached to the back surface 90 of the body 30. The suction cup can be attached by any suitable method. Preferably, the suction cup 60 has a cylindrical base 130 that is inserted within the attachment hole 120. In some embodiments, the cylindrical base 130 and attachment hole 120 are sized and shaped such that the cylindrical base 130 is press fit within the attachment hole 110. Glue or other form of adhesive may also be applied to the cylindrical base 130 prior to inserting the cylindrical base 130 into the attachment hole 120. Applying the suction cup to the outside of the beverage container 20 provides a secure yet removable attachment of the drink alert 10 to the beverage container 20.

In some embodiments, the notifier 40 is configured with a shaft 140, a flag 150, and a spring 160. See FIG. 4. The shaft can be formed of any suitable material, such as a straw or a dowel. In some embodiments, the dowel is tubular. Preferably, the flag 150 is attached to an upper portion of the shaft 140, and the spring 160 is attached to a lower portion of the shaft 140. The shaft 140 can be attached to the spring 160 in any suitable manner, but, preferably, a top portion of a cylindrical spring 160 is attached to a lower portion of a cylindrical shaft 140. In some embodiments, the shaft 140 and spring 160 are sized such that the shaft 140 can be inserted into the inner diameter of the spring 160 and the spring 160 will compress on to the shaft 140. In some embodiments, glue or other form of adhesive is applied to further secure the shaft 140 to the spring 160.

The flag 150 can be made of any suitable material and attached to the shaft 140 in any suitable manner. In some embodiments, the flag 150 is made of a paper or a fabric product and is folded around an upper portion of the shaft 140, as depicted in FIG. 4. Glue or other type of adhesive may be used to secure the flag 150 to the shaft 140. Preferably, the notifier 40 is attached to the body 30 in any suitable manner that allows relative movement between the notifier 40 and the body 30. In some embodiments, a lower portion of the spring 160 is inserted within the notifier hole 100 on the body 30. In some embodiments, the spring 160 and notifier hole 100 are sized such that a lower portion of the spring 160 is press fit within notifier hole 100. In some embodiments, glue or other form of adhesive is applied to further secure the spring 160 within the notifier hole 100. Preferably, the spring 160 is flexible, which provides relative movement between the notifier 40 and the body 30. However, it is contemplated that relative movement can be achieved by means other than a spring 160. For example, in some embodiments, the notifier 40 may not have a spring, and a flexible shaft may be attached to the body 30 that allows relative movement between the notifier 40 and the body 30.

In some embodiments, the activator 50 is configured to releasably engage the notifier 40. In some embodiments, the activator 50 is configured to maintain the notifier 40 in, for example, Position 1, and release the notifier 40 to, for example, Position 2. Preferably, relative movement is possible between the activator 50 and the notifier 40, although it does not matter which component moves with respect to the other. The activator 50 can have any design that suitably releasably engages the notifier 40. Some embodiments of the invention do not provide an activator 50, as it is contemplated that the position of the notifier 40 can be managed by other means. For example, the body 30 could be used to manage the position of the activator 50.

In some embodiments, the activator 50 comprises a latch 170, tube 180 and handle 190. Preferably, the activator 50 is attached to the body 30 in any suitable manner that allows relative movement between the activator 50 and the notifier 40. In some embodiments, the tube 180 is cylindrical and hollow and is inserted through the activator hole 110 such that portions of the tube 180 extend above and below the body 30. Preferably, the tube 180 and activator hole 110 are sized and shaped such that the shaft tube 180 is press fit within the activator hole 110. In some embodiments, glue or other form of adhesive is applied to further secure the tube 180 to the body 30.

In some embodiments, the latch 170 is a cylindrically shaped rod. The latch can be formed of any suitable material. In a preferred embodiment the latch is made of copper. Preferably, the rod is bent at about 90 degrees at one end. The straight end of the latch 170 can be inserted through the end of the tube 180 that is above the top surface 70 and extend beyond the end of the tube 180 that is below the bottom surface 75. See FIG. 1. The bent end of the latch 170 will remain above the end of the tube 180 that extends above the top surface 70. In some embodiments of the invention a tube 180 is not provided. For example, the latch 170 may extend through the activator hole 110 without being inserted through a tube 180.

In some embodiments, the handle 190 is used to cause the activator 50 to change the position of the notifier 40. In a preferred embodiment, the handle 190 can be grasped and twisted to change the position of the notifier 40. In other embodiments, the handle 190 may take the form of a button that changes the position of the notifier 40 when pressed. The handle 190 may also prevent the latch 170 from becoming separated from the body 30. In some embodiments, the handle 190 is attached to the straight end of the latch 170 that extends below the end of the tube 180. The handle 190 can be of any design that prevents the latch 170 from separating from the body 30 and allows a user to grasp the latch 170. In one embodiment, the handle 190 is a conventional wire nut. Preferably a handle 190 that is a wire nut is sized to thread onto the end of the straight end of the latch 170. Because beverages are typically served in situations in which there is group socialization, the invention in some embodiments is a publicity mechanism. The flag 150, which will likely attract the most attention, is an especially suitable feature to use as a publicity mechanism. One reason the flag 150 attracts attention is because in some embodiments it is intended to communicate the message that service is desired, which may elicit attention and commentary during group events. In some embodiments of the invention, the flag 150 includes information 200 that is viewable by those in the vicinity of the beverage container 20. In some embodiments, the information 200 is intended to publicize and/or promote a specific product, message, company, individual, or anything else for which publicity may be desired. The information 200 on the flag 150 can take any form that communicates an intended message. For example, the information 200 could be words, symbols, designs, colors, or anything else that will provide desired publicity. The information 200 in some embodiments is placed on both sides of the flag 150. Promoting advertiser information is an especially suitable purpose of the invention. The invention may be especially useful attractive to advertisers in the beverage industry, such as beverage manufacturers, beverage distributors, restaurants, bars, etc.

In an alternative embodiment, the service notification device 10 further comprises a light (not shown). Preferably, the light is located on the notifier 40 near the top of the shaft 140. It is contemplated that the light can be in any suitable location on the service notification device 10. In some embodiments, the light illuminates the information 200 that is situated on the flag 150. In some embodiments, the light serves to further attract attention to the service notification device 10 and the information 200 situated on the flag 150. This may be especially helpful when the service notification device is used in a dark bar or restaurant.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

What is claimed is:

1. A service notification device comprising:
a body;
a notifier movable with respect to the body, the notifier having a plurality of positions, at least one position communicating to a server that service is desired;
information situated on the notifier, the information providing publicity.

2. The device of claim 1 wherein the service notification device is attached to a beverage container, and the at least one position of the notification component communicates to the server that beverage service is desired.

3. The device of claim 1 wherein the notifier comprises a flag and the information is situated on the flag.

4. The method of claim 1 wherein the device further comprises a light.

5. The method of claim 4 wherein the light illuminates the information.

6. A method of publicizing information that comprises:
distributing a service notification device that is intended be placed onto a beverage container, the service notification device comprising a body and a notifier, the notifier being movable with respect to the body and having a plurality of positions, at least one position communicating to a server that beverage service is desired;
wherein information situated on the notifier is publicized.

7. The method of claim 6 wherein the notifier comprises a flag and the information is situated on the flag.

8. The method of claim 6 wherein the service notification device further comprises a light.

9. The method of claim 8 wherein the light illuminates the information.

10. A method of manufacturing a service notification device that comprises:
placing information onto a notifier;
securing the notifier to a body such that the notifier is movable with respect to the body;
wherein the notifier has a plurality of positions, and at least one position communicates that service is desired.

11. The device of claim 10 wherein the notifier comprises a flag and the information is situated on the flag.

12. The method of claim 10 wherein the notifier comprises a flag and the information is situated on the flag.

13. The method of claim 10 wherein the service notification device further comprises a light.

14. The method of claim 13 wherein the light illuminates the information.
